(19) United States
(12) Patent Application Publication
(10) Pub. No.: US 2007/0073843 A1
(43) Pub. Date: Mar. 29, 2007

(54) Method and device for video projection

(75) Inventor: Jean-Thomas Ferreri, Cergy St Christophe (FR)

Correspondence Address: LOWE HAUPTMAN BERNER, LLP, 1700 DIAGONAL ROAD, SUITE 300, ALEXANDRIA, VA, 22314, US

(73) Assignee: SAGEM COMMUNICATION, Paris Cedex 15 (FR)

(21) Appl. No.: 10/595,849

(22) PCT Filed: Nov. 19, 2004
(86) PCT No.: PCT/FR04/02947

§ 371 Date: Jun. 27, 2006

(30) Foreign Application Priority Data
Nov. 25, 2003 (FR) 0313837

(51) Int. Cl. G06F 15/16

(52) U.S. Cl. 709/219

(57) ABSTRACT

The invention relates to a video projection device, comprising at least one terminal with the video data for projection, a server and a projector, said server, being connected to the projector by a hard-wire connection and accessible from a communication network, characterised in that the terminal may be connected, by means of the network and a network access processor, to a website hosted by the server, to download a file with an .ocx extension, comprising a remote control programme for the projection with an interface (ActiveX), the running of which by the network access processor permits the projection, by a video programme suitable for the projector, of the video data displayed on the screen of the terminal.

### RELATED APPLICATIONS

The present application is national phase of PCT/FR04/002947 filed on Nov. 19, 2004 which is based on, and claims priority from, French Application Number 03 13837, filed Nov. 25, 2003, the disclosures of which are hereby incorporated by reference herein in their entirety.

### FIELD OF THE INVENTION

The present invention relates to a method and device for video projection, wireless video projection in particular.

### BACKGROUND OF THE INVENTION

Wireless video-projection devices are known in the prior art such as those shown FIG. 2. These types of devices comprise a terminal 1, a server 2 and a projector 3. Software 16 for remote controlling the projection, permitting control over the starting and stopping of the projection, must firstly be installed on the terminal 1. Video software 23 such as VNC viewer is installed on the server 2 which is connected by hardwire connection 5 to the projector 3. Execution of the remote control projection software 16 by the operating system 12 of the terminal 1 causes the transfer of video data 11 displayed on the screen 14 of the terminal 1 through a network card 10 of terminal 1 towards the server 2 via a wireless network 4. The server 2 receives these data via a network card 20 which transmits the same to the video software 23. The video software 23 then sends this data to the projector 3 which allows projection of the video data on a screen.

Through document US 2003/0 117 532 a wireless video-projection device is known in the prior art consisting of at least one mobile terminal, such as a personal organizer and a projector. The terminal and the projector each comprise a network module for wireless communication with each other. Remote control projection software is installed on the terminal, being downloaded for example from the projector. The data to be projected are transmitted to the projector from the terminal or from a data server connected by hardwire connection to the projector. With this device it is also possible to manage the projection of data emitted by several terminals on each of which remote control projection software is previously installed, enabling wireless projection of the data emitted by the different terminals either simultaneously or in a certain order.

One drawback of these prior art devices is the need to start by installing the remote control projection software on the terminal before being able to use the terminal with this projector. Also, if several persons wish to use the projector simultaneously they must all install said software on their terminals before using the projector, which is restrictive and time-consuming.

Document EP 1 244 303 teaches a wireless video-projection device with which it is possible, via a video-projector, to project audio and video data transmitted by wireless connection from a terminal such as a computer towards the video-projector, said data possibly being received from different sources. However, this device requires equipping the terminal with different modules compatible with reception of data derived from different sources. In addition, these modules must permit transformation of the data so that they are compatible with the video-projector.

Document US 2003/0 081 561 teaches a wireless video-projection device comprising a computer and a video-projector. This device requires encrypting of the data by the computer and decrypting of the coded data by the projector. The video-projector can therefore only be used with a computer provided with a specific encrypting module compatible with the decrypting module of the video-projector, which necessitates installing said module on the computer from which the data is to be projected.

Document US 2002/0 098 819 teaches a wireless video-projection device comprising a computer, a server and a video-projector, the presence of the server eliminating the need to modify the computer. In this device, the server is controlled by a console controlled by an operator. The disadvantage of this device is that it is complex.

### SUMMARY OF THE INVENTION

The purpose of the present invention is to remedy some disadvantages of the prior art by proposing a simple video-projection device with which it is possible to remotely control projection without modifying the terminal containing the data to be projected.

This purpose is achieved with a video-projection device comprising at least one terminal containing video data to be projected, a server and a projector, the server firstly being connected to the projector by hardwire connection and secondly being accessible via a communication network, characterized in that the terminal is connectable, via the network and network access software, to a web site hosted by the server in order to download, via access to this web site, an *ocx extension file comprising remote control projection software offering an interface whose execution by the network access software enables the projection, by video software adapted to the projector, of video data displayed on the terminal screen.

According to another aspect, the terminal and the server each comprise a network card enabling them to connect to the communication network and to communicate together via this network.

According to a further aspect the network is a wireless network.

Another purpose of the invention is to propose a method for video-projecting video data displayed on the terminal screen.

This purpose is achieved by a method characterized in that it comprises at least the following steps:
executing network access software on the terminal to allow connection of the terminal to an Internet communication network,
entering a determined URL address into the network access software to access a web site hosted by a server via this communication network,
downloading a web page from said web site into the network access software of the terminal, which page is linked to an .ocx extension file comprising remote control projection software offering an interface, enabling the network access software and scripts of the web page to execute and control the .ocx extension file,
sending video data displayed on the terminal screen to the communication network through execution of the .ocx extension file by the network access software,
receiving video data by video software adapted to the video-projector which is installed on the server, and transmitting the data to the video-projector.

According to another characteristic, the video data, before being sent to the server, is compressed by the .ocx extension file then, before being sent to the video-projector, is decompressed by the video software.

According to another characteristic, stopping of the projection is achieved by closing the network access software on the terminal.

According to another characteristic, execution of the .ocx extension file is prompted by activation of a button associated with the execution function of the .ocx extension file and shown on the web page with which the .ocx extension file is linked.

According to another characteristic, stopping of the projection is prompted by activation of a button associated with the stopping function of the execution function of the .ocx extension file and shown on the web page with which the .ocx extension file is linked.

### BRIEF DESCRIPTION OF THE DRAWINGS

Other characteristics and advantages of the present invention will become more apparent on reading the description given below made with reference to the appended drawings in which:

FIG. 1 shows the inventive video-projection device.

FIG. 2 shows a prior art video-projection device.

### DETAILED DESCRIPTION OF THE DRAWINGS

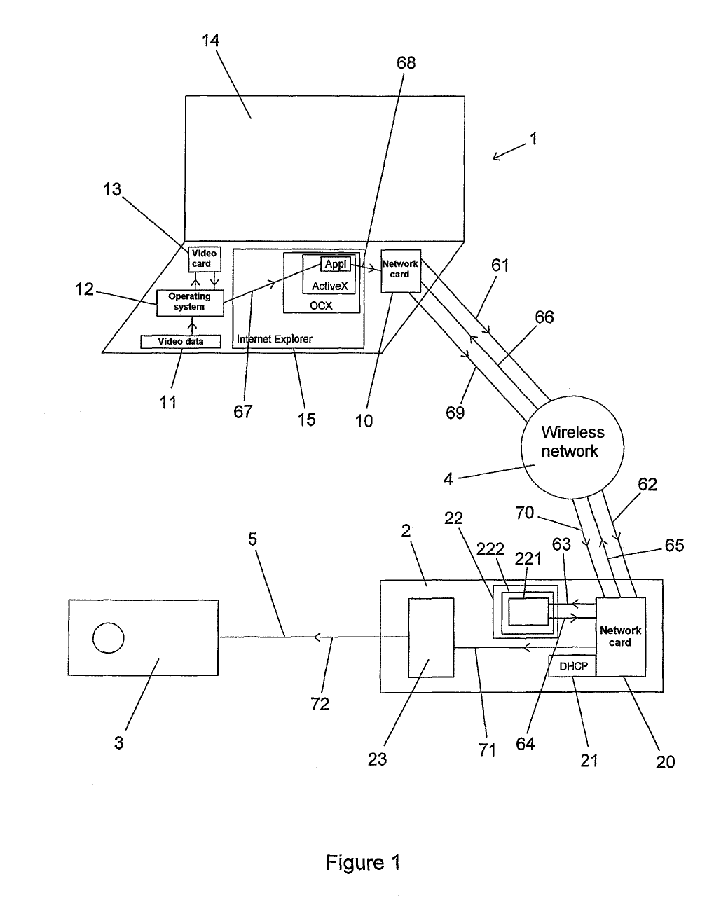

The video-projection device of the invention, shown FIG. 1, comprises at least one terminal 1, a server 2, and a projector 3, the server 2 and projector 3 being connected by communication means 5 such as a hardwire connection for example. The terminal 1 is preferably but not limited to a laptop computer. The terminal 1 and server 2 each comprise a network card (10 and 20 respectively) enabling them to connect to a communication network and to communicate together via this network. This network is preferably a wireless network 4 such as Wi-Fi, Bluetooth, GSM, etc..

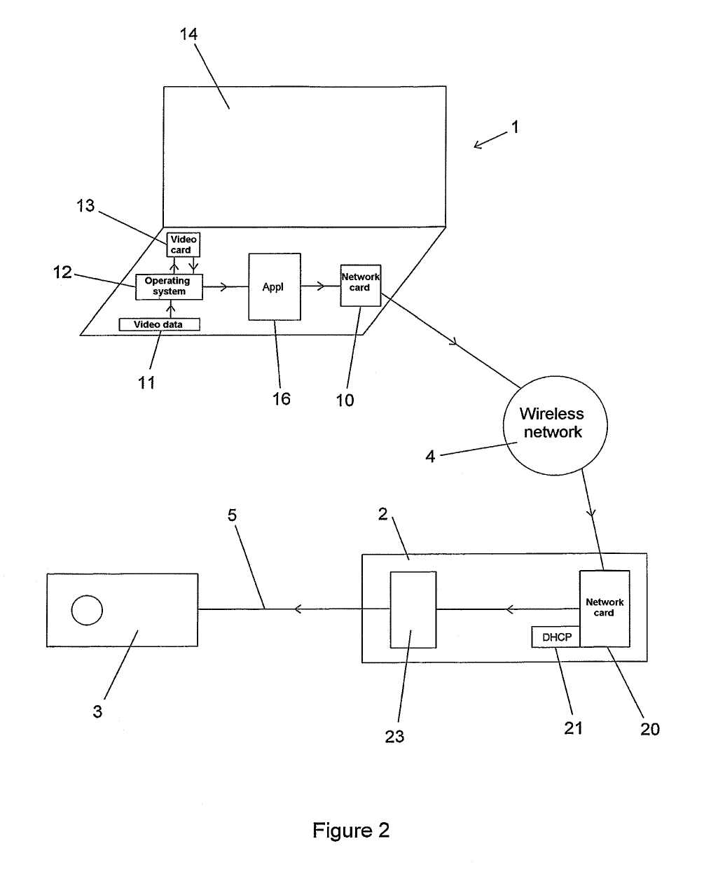

The invention consists of a device and a method, using the video-projector 3 for projection onto a screen (not shown) of a conference room, for projecting video data 11 displayed on the screen 14 of terminal 1 by the operating system 12 of the terminal 1 via the video card 13 of the terminal 1 onto the screen of the projection room, without having to install any remote control projection software 16 on the terminal 1 as in the prior art (FIG. 2), which is a lengthy, cumbersome operation requiring the possession of various different software programmes 16 equal in number to the terminals on which they were to be installed.

For this purpose, a network access software program 15, e.g. Internet Explorer but not limited thereto, is previously installed on terminal 1. This step is generally conducted at the time of purchasing the terminal.

Also, the server 2 connected to the video-projector comprises a HTTP server (Hyper Text Transfer Protocol) which hosts a web site 22 corresponding to a determined URL address. This web site 22 comprises at least one web page with which at least one .ocx extension file is linked that contains the remote control projection software 221 offering an ActiveX interface 222 enabling the network access software 15 and scripts of the web page to execute and control the ocx. extension file.

The server 2 also comprises a DHCP server (Dynamic Host Configuration Protocol) 21 enabling connection of the terminal 1 to the server 2 via a Wi-Fi network, and video software 23 which receives the video data 11 directly from terminal 1 that is transmitted during execution of the .ocx extension file and which sends the same to the video-projector 3 by hardwire connection 5.

The video-projection method of the invention comprises a first step to execute the network access software 15 on the terminal 1 by the terminal user. If the terminal 1 is a laptop computer, it attempts to connect to a wireless network 4, a WiFi network for example, by seeking the closest DHCP server, which will allocate to it a dynamic IP address. In the invention this will be the DHCP server 21 coupled to the network card 20 of the server 2. The second step of the method consists of entering into the network access software 15 on terminal 1 the URL address corresponding to the web site 22 hosted by the server 2. The terminal 1 then connects (61, 62, 63) to the web site 22 of the server 2 passing through the wireless network 4 via the network cards (10, 20) of the terminal 1 and server 2. The web page with which the .ocx extension file is linked is then loaded (64, 65, 66) in the network access software 15 of the terminal 1 passing through the wireless network 4 via the network cards 10, 20 of the terminal 1 and server 2. Said web page, with which the .ocx extension file comprising remote control projection software 221 is linked, is therefore loaded in a memory of the terminal with the .ocx extension file at the location provided for web pages of the network access software 15. As soon as said web page is loaded on the terminal 1, the corresponding data is displayed on the screen of the terminal 1, and the .ocx extension file is spontaneously executed. The instructions of the .ocx extension file comprising the remote control projection software 221 are interpreted directly in the language of the network access software 15 and are executed by the operating system 12 (e.g. Windows) of the terminal 1. This execution enables the sending (67, 68, 69, 70, 71) of the video data 11 intended to be displayed on the screen 14 of terminal 1, firstly towards the video card 13 associated with the screen 14 and secondly through the network card 10 of the terminal 1 towards the video software 23 of the server via the wireless network 4. The video data is converted by the remote control projection software into a format comprehensible by the video software 23 of the server 2 before being sent to the server 2. The video software 72 then transfers the video data to the projector 3 via the communication means 5. The .ocx extension file optionally compresses the video data before sending it to the server 2. In this case, the video software 23 decompresses this data before transmission step 72 towards the projector 3.

In one variant of embodiment, the .ocx extension file is not executed spontaneously, but subsequent to activation of a button, for example the “ON/OFF” button displayed on the web page, activated by a mouse click for example, this activation of the button causing execution of a script written in Javascript for example which launches execution of the .ocx extension file.

Therefore, as soon as the network access software (15) is closed, or as soon as a second click is made on the “ON/OFF” button of the web page (depending upon variant), the projection and transmission of data are stopped.

In a variant of embodiment, not shown, the server 2 is integrated in the projector 3.

In another variant of embodiment, the wireless network 4 is replaced by a hardwire network. The server 2 is therefore also equipped with an adequate module, ADSL for example.

Therefore as soon as the web page, with which the .ocx extension file containing the remote control projection software is linked, has been loaded by the network access software 15, such as the Internet Explorer navigator, the video data 11 intended to be displayed on the screen 14 of the terminal 1 is transmitted to the server 2 which is connected to the video-projector 3 which contains the video software 23, of VNC viewer type for example, and the .ocx extension file containing the remote control projection software is executed without the need for its installation on the terminal 1. As soon as the connection is interrupted by closing the network access software 15, such as Internet Explorer, the .ocx extension file containing the remote control projection software is deleted from the RAM memory of the terminal 1. Video-projection is only subsequently possible if a new network access to the HTTP server containing the web page 22 defined by the determined URL address is made by the user of terminal 1 by launching the network access software 15, such as Internet Explorer, with the determined URL address.

It will be obvious for those skilled in the art that the present invention allows embodiments in numerous other specific forms without departing from the scope of application of the invention as claimed. Therefore the present embodiments must be considered as illustrations which may be modified within the area defined by the scope of the appended claims, and the invention is not to be construed as being limited to the details given above.

1. Video-projection device comprising at least one terminal including video data to be projected, a server and a projector, the server being connected to the projector by hardwire connection and being accessible via a communication network, terminal being connectable, via the network and network access software to a web site hosted by the server, to load an .ocx extension file including remote control projection software offering an interface whose execution by the network access software allows the projection, by use of video software adapted to the projector, of the video data displayed on the screen of terminal.

2. Video-projection device as in claim 1, wherein the terminal and the server each comprise a network card enabling them to connect to the communication network and to communicate together via the communication network.

3. Video-projection device as in claim 2, wherein the communication network includes a wireless network.

4. A method of video-projecting video data displayed on a screen of a terminal, the method comprising:
executing network access software on the terminal the terminal is connected to an Internet communication network,
entering a determined URL address into the network access software to access a web site hosted by a server via the Internet communication network,
downloading a web page from said web site in the network access software of the terminal, with which an .ocx extension file is linked, the software comprising remote control projection software offering an interface (ActiveX) enabling the network access software and the scripts of the web page to execute and control the .ocx extension file.
sending video data displayed on the screen of the terminal to the communication network by executing the .ocx extension file with the network access software,
receiving video data by video software adapted to the video-projector, which is installed on the server, and transmitting data to the video-projector.

5. Video-projection method as in claim 4, wherein the video data, before being sent to the servers, is compressed by the .ocx extension file then, before being sent to the video-projector, is decompressed by the video software.

6. Video-projection method as in claim 5, wherein the stopping of projection is prompted by closing the network access software on the terminal.

7. Video-projection method as in claim 5, wherein execution of the .ocx extension file is prompted by activating a button associated with the .ocx extension file execution function, and shown on the web page with which the .ocx extension file is linked.

8. Video-projection method as in claim 7, wherein stopping of the projection is prompted by activation of a button associated with the stop function of the .ocx extension file execution function and shown on the web page with which the .ocx extension file is linked.

9. Video-projection method as in claim 5, wherein the stopping of projection is prompted by closing the network access software on the terminal.

10. Video-projection method as in claim 5, wherein execution of the .ocx extension file is prompted by activation of a button associated with the .ocx extension file execution function, and shown on the web page with which the .ocx extension file is linked.

11. Video-projection method as in claim 4, wherein the stopping of projection is prompted by closing the network access software on the terminal.

12. Video-projection method as in claim 4, wherein execution of the .ocx extension file is prompted by activating a button associated with the .ocx extension file execution function, and shown on the web page with which the .ocx extension file is linked.

13. Video-projection method as in claim 12, wherein stopping of the projection is prompted by activation of a button associated with the stop function of the .ocx extension file execution function and shown on the web page with which the .ocx extension file is linked.
